(19) United States
(12) Patent Application Publication
(10) Pub. No.: US 2020/0301953 A1
(43) Pub. Date: Sep. 24, 2020

(54) INDICATING SYNONYM RELATIONSHIPS USING SEMANTIC GRAPH DATA

(71) Applicant: MicroStrategy Incorporated, Vienna, VA (US)

(72) Inventors: Saurabh Abhyankar, McLean, VA (US); Scott Rigney, Arlington, VA (US); Timothy Lang, McLean, VA (US)

(21) Appl. No.: 16/677,427

(22) Filed: Nov. 7, 2019

Related U.S. Application Data
(60) Provisional application No. 62/821,132, filed on Mar. 20, 2019.

(51) Int. Cl. G06F 16/332; G06F 16/36; G06K 9/72; G06K 9/62; G06F 16/335; G06F 16/35; G06N 5/02

(52) U.S. Cl. CPC G06F 16/3328; G06F 16/374; G06K 9/726; G06N 5/022; G06F 16/337; G06F 16/358; G06K 9/623

(57) ABSTRACT

Methods, systems, and apparatus, including computer programs encoded on computer-readable storage media, for indicating synonym relationships using semantic graph data. In some implementations, semantic graph data indicates a semantic graph that includes elements representing objects and that indicates relationships among the objects. Synonym data that indicates synonym relationships among terms associated with the objects represented by the elements is stored in association with the semantic graph data. A request to provide information using the semantic graph is received. One or more results are generated based at least in part on the synonym data stored in association with the elements of the semantic graph. The one or more results are provided in a response to the request.

### CROSS-REFERENCE TO RELATED APPLICATION

This application claims the benefit of U.S. Provisional Patent Application No. 62/821,132, filed on Mar. 20, 2019, the entirety of which is incorporated by reference herein.

### TECHNOLOGICAL FIELD

The present specification relates to providing indicating synonym relationships using semantic graph data.

### BACKGROUND

Many database systems, analytics systems, search engines, and other computing systems receive and process information expressed in natural language. The richness of natural language often results in many different words and phrases being used to refer to the same or similar items. Many computing system are not equipped to recognize when synonyms are used, which can limit the effectiveness of information retrieval, database processing, natural language understanding, context analysis, and many other operations.

### SUMMARY

In some implementations, a computing system stores semantic graph data indicating objects and relationships among the objects. The system can specify synonym relationships between different terms using the semantic graph data. For example, object nodes and connections between the nodes can be associated with data that specifies synonyms. Using the semantic graph, the system can inform various systems and processes of the synonym relationships to enhance processing. The synonyms indicated by the semantic graph can be used throughout an analytics system, for example, to interpret or revise a user's query, to identify search results, to generate recommendations, to detect topics or contexts, and so on. Storing synonym relationships in the semantic graph allows all processing that leverages the semantic graph to benefit from those relationships. In addition, including synonym information in the semantic graph facilitates the automatic discovery and updating of synonym relationships by the system.

Dealing with synonyms is a fundamental challenge for analytics systems, database systems, and other systems that process natural language information. In many cases, multiple different terms refer to the same concepts, documents, and data elements. Different systems and different users often refer to the same items using different terms, or using different spellings and variations of the same terms. As a result, systems that rely on string-to-string matching of terms often fail to identify relevant content because the content is associated with different terms having the same or similar semantic meaning.

Enabling a semantic graph to indicate synonym relationships can provide a central, unified source of synonym information that can inform any operation involving the semantic graph. Semantic graph data can indicate synonyms in any of various ways. As an example, the data that defines a node in the semantic graph can include or be linked to data specifying synonyms for the item the node represents and/or synonyms for attributes of the item. As another example, the semantic graph can have certain connections or edges that represent synonym relationships. As another example, the semantic graph data can include weight values or other scores that specify the strength of synonym relationships (e.g., a level of similarity of meaning between two terms, a confidence level that two terms are synonyms, and so on).

The system can provide various ways for synonym information to be integrated with or injected into the semantic graph. For example, the system can provide a user interface and/or application programming interface (API) that can be used to explicitly specify synonyms for terms. The system can also infer synonym relationships automatically from the contents of a database, document collection, or other data source, for example, based on co-occurrence of terms and interchangeability of terms. In many cases, synonym relationships can be learned using machine learning processes that analyze information from a data source and recognize usage patterns of different terms that are indicative of synonym relationships. Synonyms can also be identified from analysis of user actions and user behavior. For example, if different users apply different names to the same item, such as a particular column in a data table, the different terms can be identified as potential synonyms. Similarly, indications of common meanings can be detected by monitoring other types of user actions, such as edits to re-name an item, apply a label, enter an annotation, and so on. The system may also obtain synonym information from third-party systems, synonym tables, dictionaries, and other sources.

As the semantic graph and other functionality are used, the system can use the interactions of users and changes in data sets to learn and adapt synonym relationships over time. This process can occur dynamically and on an ongoing basis. Some changes may be discrete, such as adding or removing a term as a synonym for another. Other changes can be gradual or progressive, such as to increase or decrease a value specifying the strength of a synonym relationship as usage of a synonym increases or decreases, or to alter the contexts in which terms are considered to be synonyms. In addition, the learning of the system may occur through passive means, such as analysis of existing data sets and action logs, or through active means, such as by providing question prompts for users to confirm synonym relationships or by presenting different user interfaces to different sets of users to measure effects of potential synonyms on user actions.

In some implementations, the semantic graph and the synonym relationships specified by the semantic graph are customized for a specific organization, such as a company. This allows the semantic graph and synonym relationships to reflect the data of the organization's own documents and data sources, which can include public databases, private databases, and combinations of them. As a result, a separate semantic graph can be generated and used for each of multiple different organizations, allowing each organization to obtain customized search results, recommendations, and other outputs based on its data and the usage of its own users. Similarly, different synonym relationships can be indicated by the semantic graphs of different organizations, since the synonym relationships for each organization can reflect the usage of terms in the organization's own documents and data and usage of the organizations own users.

In general, the system can discover, test, record, and publish synonym relationships. Each of these actions can make use of the semantic graph. For example, the system can assess semantic graph data indicating between the strength of connections between different objects and different terms. The semantic graph data can also be used to determine when user actions refer to the same objects (e.g., data elements) and so may involve terms with the same semantic meanings. Once candidate synonym relationships are identified, the system can perform tests to determine which candidate synonym relationships are valid, and in which contexts different terms are appropriately considered to be synonyms. The system can record synonym relationships in the semantic graph or in associated data. For example, synonyms can be specified in data defining nodes and edges of the semantic graph, or in other data that references identifiers for the nodes and edges of the semantic graph. In some implementations, synonym relationships may be additionally or alternatively be indicated through scores or weightings for edges or other connections of elements in the semantic graph. Integrating these synonym relationships with the semantic graph can effectively publish the synonym relationships throughout an enterprise system. For example, whenever a request is made to a semantic graph service, the response of the system can take into account the synonym relationships defined. As a result, requests to identify relevant objects, indicate the strength of connections between objects, to recommend objects for a particular context, and others may all be enhanced by the synonym relationships of the semantic graph.

In some cases, the synonym relationships indicated by the semantic graph can be context-dependent. For example, the semantic graph data may indicate that in the context of a particular topic, like a particular shoe company, the words “product” and “shoes” may be synonyms, even though the two many not be synonyms in other contexts.

The system can stores usage information associated with objects represented in the semantic graph. The usage information can be stored at a fine-grained level to indicate various contextual factors associated with actions taken using business analytics information. For example, usage data can be generated and stored on a user-specific basis, and for individual access actions in the system. The usage data can identify accessed data elements or other objects (e.g., documents, document components, data sources, database records, entity metrics, etc.), as well as the context of the access (e.g., a user identity, a user role, user permissions, an applicable task or workflow, a pattern of accesses, an application used, etc.). A wide variety of types of usage can be tracked and stored in usage data, including actions to retrieve, generate, edit, save, share, and so on.

The system associates the accesses with the semantic graph and uses the context-based usage data to adjust the weights for connections between objects represented in the semantic graph. The usage data is also used to customize or personalize output of the computing system, so that when the semantic graph is queried to perform an action (e.g., to generate a recommendation, suggestion, prediction, etc.), the output is customized due to the current context of the user and the respective contexts associated with prior usage by the user and other users. For example, the weights in the semantic graph may be dynamically adjusted using a customized aggregation or weighting of the context data according to the similarity of the user's current context with the contexts of prior usage actions. In this manner, different users can have different customized weightings for the same objects and connections based on the usage history of the objects represented in the semantic graph and the respective contexts of the users of the system. This type of customization or personalization can be used to detect and apply synonym relationships that may be strong and valid for certain users, user groups, or topics, but which may not be applicable more generally. For example, knowing that users in a particular department or users discussing a particular topic often use certain terms as synonyms can significantly enhance the system's ability to process data and queries involving those terms.

In one general aspect, a method performed by one or more computers includes: storing semantic graph data indicating a semantic graph that includes elements representing objects and that indicates relationships among the objects; storing, in association with the semantic graph data, synonym data that indicates synonym relationships among terms associated with the objects represented by the elements; receiving a request to provide information using the semantic graph; generating one or more results based at least in part on the synonym data stored in association with the elements of the semantic graph; and providing the one or more results in a response to the request.

In some implementations, storing the synonym data includes storing synonym data that refers to identifiers for the elements of the semantic graph or the objects represented by the elements.

In some implementations, storing the synonym data includes storing scores indicating different strengths of synonym relationships among different pairs of terms.

In some implementations, storing the synonym data includes storing data indicating a synonym relationship that was manually entered by a user.

In some implementations, the objects represented by the elements are identified from a database for a particular organization.

In some implementations, the semantic graph includes connections among elements representing the objects, and the connections are determined (i) from data or documents of a particular organization and (ii) user interactions of users in the particular organization.

In some implementations, the method includes providing access to the semantic graph as a semantic graph service accessible through an application programming interface. Receiving the request includes receiving a query for the semantic graph service through the application programming interface. Providing the one or more results includes providing data identifying objects represented in the semantic graph as output of the semantic graph service.

In some implementations, the method includes: identifying a first term as a candidate synonym for a second term; validating the candidate synonym relationship based on usage information indicating user actions with respect to the first term and the second term; and based on validating the candidate synonym relationship, updating the synonym data to indicate that the first term is a synonym for the second term.

In some implementations, identifying the first term as a candidate synonym for the second term includes: determining that one or more users have applied the first term as a label for an item; and determining that one or more users have applied the second term as a label for the item.

identifying the first term as a candidate synonym for the second term includes: determining a measure of co-occurrence, interchangeability, or affinity for the first term and the second term based on contents of documents or data of a particular organization; and determining that the measure satisfies a predetermined threshold.

In some implementations, validating the candidate synonym relationship includes: providing first data to a first set of users, the first data including the first term; providing second data to a second set of users, where the second data includes the first data with the second term used in place of the first term; tracking actions of users in the first set of users and the second set of users after presentation of the first data and the second data; and determining, based on the tracked actions, that the first term is a synonym for the second term.

In some implementations, validating the candidate synonym relationship includes analyzing instances of the first term and the second term in different contexts to determine whether the synonym relationship remains valid in each of the different contexts.

In some implementations, updating the synonym data to indicate that the first term is a synonym for the second term includes updating the semantic graph data to add a synonym to data describing one or more elements of the semantic graph.

In some implementations, updating the synonym data to indicate that the first term is a synonym for the second term includes updating the semantic graph data to add a new node to the semantic graph that specifies that the first term is a synonym for the second term.

In some implementations, updating the synonym data to indicate that the first term is a synonym for the second term includes updating the semantic graph data to add a new edge to the semantic graph that specifies that the first term is a synonym for the second term.

In some implementations, the method includes monitoring user actions, document content, content of data stores over time to dynamically adjust synonym relationships indicated by the synonym data.

In some implementations, the synonym data includes scores that indicate differing strengths of relationships for different synonym pairs, and the method includes altering the scores based on user interactions with data elements associated with the terms in the synonym pairs.

Other embodiments of these aspects include corresponding systems, apparatus, and computer programs encoded on computer storage devices, where the systems, apparatus and computer programs are configured to perform the actions of the methods. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for indicating synonym relationships using semantic graph data.

FIG. 2 is a diagram showing an illustration of a semantic graph.

FIGS. 3A-3E are tables showing examples of synonym information.

FIG. 4 is a diagram indicating an example of using synonym information integrated with a semantic graph.

FIG. 5 is a flow diagram illustrating an example of a process for indicating synonym relationships using semantic graph data.

Like reference numbers and designations in the various drawings indicate like elements.

### DETAILED DESCRIPTION

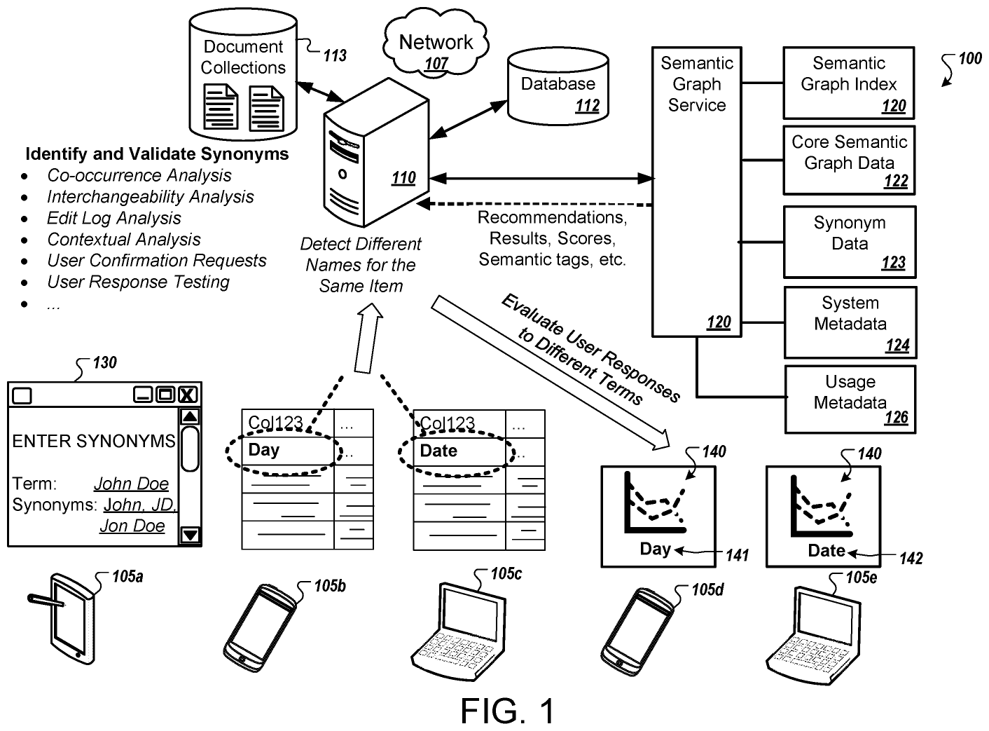

FIG. 1 is a diagram showing an example of a system 100 for indicating synonym relationships using semantic graph data.

In general, semantic information can be used by many types of enterprise systems, such as database systems, online analytical processing (OLAP) systems, search engines, and others. Traditionally, semantic data is used to translate database table and other data formats into human-readable forms. Semantic data can provide information about the identity of objects, the meaning of different objects, relationships among objects, and so on. For example, semantic information may indicate that a particular column of data represents a particular attribute or metric and may indicate the data type of the data. Semantic data that indicates the categories or types of objects is useful, but labels and classifications alone typically do not indicate the full scope of the complex interactions, relationships, and histories among objects.

In general, the semantic graph provides an ability to better provide personalized, contextualized information from what otherwise may be a sea of static and flat data without the semantic graph and associated metadata. A semantic graph can indicate enhanced relationships between objects. For example, the semantic graph can include different weights for connections between objects, and the values of the weights can vary dynamically over time. In addition, the semantic graph may indicate multiple different types of connections between objects, as well as specifying directionality of the connections.

The semantic graph and associated metadata can be used to automatically generate personalized recommendations and content to end users, for example, based on the identity of the user and the user's current context. The semantic graph can be used to associate objects with telemetry information, such as usage information that indicates how objects are used, how often objects are used, who the objects are used by, and so on. The relationships modeled with the semantic graph can be varied and complex. Even for only two objects, there may be a multi-dimensional connection between them with different weights representing strengths of different relationships or properties. In this sense, there may be multiple connections between objects representing different types of relationships or different aspects of a relationship (e.g., one weight for co-occurrence frequency in documents, another weight for a degree that one object defines the meaning of the other, another weight for how commonly objects are accessed by the same users, and so on). The weights for the connections dynamically adjusted over time. With this information, applications can better identify which objects out of a large set (e.g., thousands, millions, or more) are most important and most related to each other.

Many different types of objects can be identified and characterized using the semantic graph. For example, objects may represent data sources, data cubes, data tables, data columns, data fields, labels, users, locations, organizations, products, metrics, attributes, documents, visualizations (e.g., charts, graphs, tables, etc.), and many other data items or concepts.

Usage information can be stored for each object, as well as for each user. The semantic graph may be interpreted differently for each user. For example, the user context (e.g., the identity, permissions, and usage history for the current user) can provide a personalized lens to interpret the data. User information can be used to adjust the weights in the semantic graph to alter search results, recommendations, application behavior, and other aspects of the user's experience. As discussed below, other types of context can also be captured and stored, such as data indicating a user's geographic location, the identity of a user's device, a device type or capabilities of the user's device, a time of day, an identity of another user or device nearby, an application open on the user's device, text on a user interface, a current task or workflow, keywords of recent queries or recently viewed documents, and so on.

The semantic graph can also indicate weights for levels of security, access restrictions, and trust for objects. For example, the semantic graph data can indicate the status of certain objects being certified or not, as well as the level of certification and the authority that provided the certification. Certified content is often more useful than content that is not certified, and so application content can give higher weight or higher preference to certified content. In general, the connections and weights for the semantic graph can indicate higher weights for higher-quality content.

The semantic graph provides a framework to integrate various different types of data from different sources, e.g., presence data indicating locations of users, access control data indicating user privileges, real-time application context, user interaction histories, query logs, and so on. Further, the relationships between objects are not limited to a particular use or domain. For example, the usage information and history that is generated from user-submitted search queries and responses can affect the weights between objects used for much more than carrying out searches, e.g., also for personalizing an interface for document authoring, for system performance tuning, for recommending documents, and more.

The semantic graph, through the various associated weights for connections between objects, provides a very useful way for a system to understand the relative weights between objects. In many cases, the meanings of different items and their relative importance is revealed over time through usage information, such as the frequency with which that users use certain objects together in document or a particular visualization. The overall amount of use of different objects (e.g., number of accesses over a period of time) is also a strong signal that can be used to rank objects relative to each other.

As users interact with an enterprise platform, they contribute information and meaning to the semantic graph. As an example, a database may have a column labeled “EFTID,” and the user may know that values in the column represent a unique customer unique ID. The system obtains new information about the meaning of the column as the user interacts with the data, for example, by renaming the column, referencing the data in a visualization, using the data in an aggregation or along an axis, etc. The understanding and context that the user has (e.g., by understanding the meaning of the data) can be at least partially revealed to the system through the user's use of the data over time. The system uses the usage data to capture these indications of meaning and feeds them back into the graph, e.g., through adjusting connections between objects and adjusting weights for connections. A number of contextual cues from user actions can be identified by the system and used to update the semantic graph and optimize the operation of the system.

Information in the semantic graph and associated metadata can be stored on a user-by-user basis and/or at other levels of aggregation (e.g., by user type, by organization, by department, by role, by geographical area, etc.). Usage information is often stored on a per-user basis to indicate the particular actions users take and items viewed. Users can also be grouped together and their respective usage information aggregated. For example, users may have data in the semantic graph indicating their attributes, such as their organization, department, role, geographical area, etc. The system then uses that information to determine the overall usage patterns for a group of users. For example, to determine usage patterns for users in a particular department, the system can identify user objects in the semantic graph that have a connection of a certain type (e.g., a “member of” connection) to the particular department. With this set of users, the system dynamically combines the sets of usage data for the individual users identified. In this manner, the system can aggregate usage logs, system performance data, and other information at any appropriate level as needed.

In the example of FIG. 1, a server system 110 provides analytics functions to various client device 105a-105c. The analytics functions can include serving documents, answering database queries, supporting web applications, generating documents (e.g., reports, dashboards, etc.), and so on. The server system 110 can include one or more computers, some of which may be remotely located or provided using a cloud computing platform. The server system communicates with the client devices 105a-105e through a network 107.

The server system 110 has access to a database 112 that stores data that is used to provide the analytics functions. For example, the database 112 may store documents, data sets (e.g., databases, data cubes, spreadsheets, etc.), templates, and other data used in supporting one or more analytics applications. The information in the database 112 can be stored as structured data, semi-structured data, unstructured data, or in any appropriate form. The server system 110 may additionally or alternatively access document collections 113, which can include documents created, accessed, edited, or otherwise used by users of the system. In some implementations, the documents may be served by the server system 110 or a related server.

The server system 110 stores data for a semantic graph, which can include, among other data, a semantic graph index 120, core semantic graph data 122 (e.g., including object definitions, semantic tags, identifiers for objects and connections, etc.), synonym data 123, system metadata 124, and usage metadata 126.

The system may be arranged to provide access to the semantic graph through a semantic graph service 120. For example, the system may provide an application programming interface (API) allowing software modules to look up different information from the semantic graph. The semantic graph and associated metadata can be stored in various formats. As an example, a core set of structured metadata identifying objects and their properties can be stored in a database. Additional associated data can be stored in the same manner or at other locations. For example, a high-speed storage system can store and update usage metadata, system metadata, and other types of information that are constantly being updated to reflect new interactions. This metadata can be associated or linked to the core structured metadata for the objects by referencing objects through the identifiers or other references defined in the core semantic graph structured metadata. The semantic graph service 120 may then provide information to influence various other functions of the enterprise system, such as a search engine, a content recommendation engine, a security or access control engine, and so on. Although the storage of the semantic graph data and associated metadata may be stored at diverse storage locations and across different storage systems, the semantic graph service 120 provides a unified interface for information to be delivered. Thus, the service 120 can provide access to diverse types of data associated with the semantic graph through a single interface. The semantic graph service 120 can provide a consistently available, on-demand interface for applications to access the rich interconnectedness of data in an enterprise system.

As an example, a query response engine can submit a request to the semantic graph service 120 that indicates a certain context. The context information may indicate, for example, user context (e.g., a user identifier), location context (e.g., GPS coordinates or a city of the user), application context (e.g., a document being viewed), or other contextual factors. In some cases, the request indicates one or more context objects (e.g., user objects, location objects, document objects, etc.) and the semantic graph service 120 provides a list of the related objects and scores of how relevant the results are to the context objects. If a recommendation engine submits a request for results of a certain type (e.g., documents, media, etc.) given a certain context, the semantic graph can provide results that identify objects selected based at least in part on the particular usage history and other data associated with the context. The semantic graph service 120 may use both general weights and usage information, e.g., across all users, as well as specific weights and usage information tailored to the context. For example, all using data may be used to define a general weight that is used for a connection in the semantic graph when no specific context is specified. When a user context is specified, the general weight may be adjusted based on user-specific usage data and weightings. Thus the results from the semantic graph service 120 can blend general and context-specific information when appropriate. Of course, if specified in a request or for certain types of requests, responses for a context may be generated using only metadata relating to the context in some implementations.

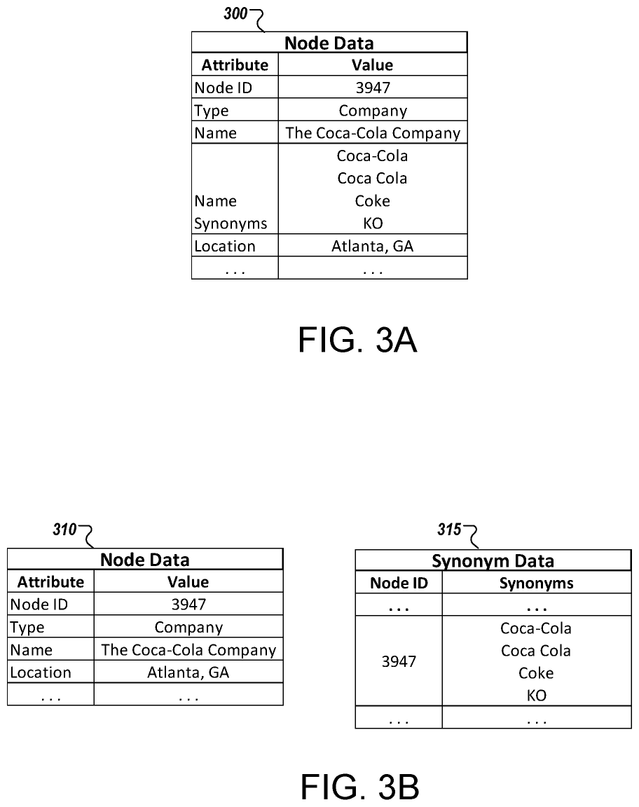

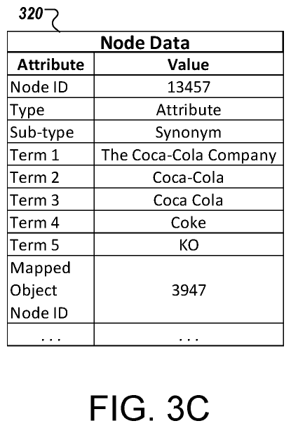

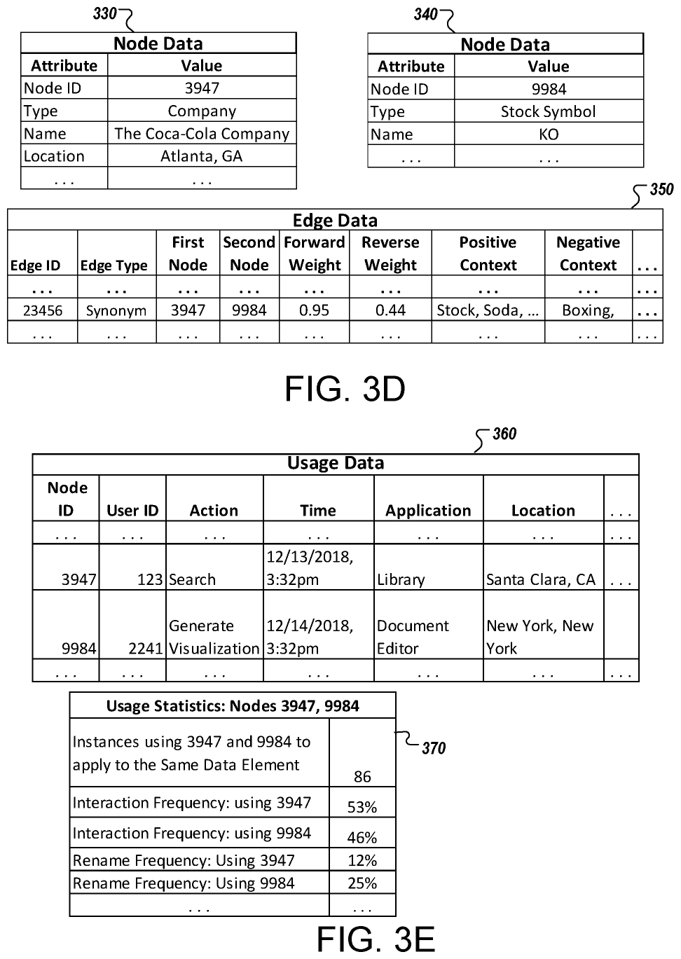

Referring still to FIG. 1, the server system 110 can store and use information about synonym relationships in any of a variety of ways. The synonym data 123 can include synonym tables or other mappings between terms having the same or similar meanings. The synonym data 123 can also store weights or other scores indicating the strength or confidence levels for the synonym relationships. The synonym data 123 can also specify contextual factors that affect the relevance or strength of synonym relationships. For example, in the context of vehicles, the term “Jaguar” may be specified as a synonym for a luxury car manufacturer, but in the context of animals, the term may be a synonym for “cat” or “predator.” The synonym data 123 can specify synonyms by referencing identifiers for nodes, objects, edges, or other elements. Synonym information can also be stored in the core semantic graph data 122, such as by specifying nodes and/or edges that represent the synonym relationships. For example, the semantic graph can include nodes corresponding to synonym objects that specify terms that are alternatives for each other. Various examples of storing synonym information in or associated with a semantic graph are provided in FIGS. 3A-3D.

The server system 110 can perform various operations to identify and validate synonym relationships. This processing is useful to identify synonyms when building a semantic graph, as well as on an ongoing basis to extend and adapt the semantic graph to changing data sets and changing usage patterns from users. The server system 110 can perform analysis automatically to identify new sets of synonyms and record them for used in the semantic graph. For example, the server system 110 can identify and test candidate synonym relationships using co-occurrence analysis to evaluate how frequently and consistently terms are used together, interchangeability analysis to evaluate the extent that users use different terms in place of each other, edit log analysis to evaluate how users' changes to documents and data sets reflect commonality in the meanings of terms, contextual analysis to evaluate how terms are used in different contexts, user interaction analysis including consideration of explicit user confirmations, and user response testing to evaluate user actions performed after users have been shown different terms in outputs of the system.

In further detail, one way the server system 110 enables synonym relationships to be added is through manual input from a user through a user interface (e.g., a web page, a web application, a native application, etc.) The client device 105a provides a user interface 130 in which a user can manually specify synonyms, such as by typing in synonyms or selecting from a set of options (e.g., abbreviations, related terms, etc. determined from analysis of documents or database content). In the example, a user has entered synonyms for “John Doe” to be “John,” “JD,” and “Jon Doe.”

Candidate synonyms for a term can be identified through various types of analysis. The server system 110 can analyze the information in the database 112 and the document collections 113 to determine the frequency that different terms occur together. Similarly, the server system 110 can determine the frequency that different terms occur in the same context, e.g., related to the same topics, objects, and surrounding words or other content. The server system 110 can also determine how often different terms are used interchangeably, such as different terms being used in the same or similar surrounding content but with one term substituted for another. For example, two terms can be identified as potentially synonymous if there are multiple copies of a document and some versions include a first term in a phrase or other content, and other copies include a second term in the same phrase or other content. A common meaning can also be identified using edit logs or other historical information indicating changes that users have made to documents and data sets over time. The logs may show, for example, that different versions of a document have had text changed from a first term to a second term, and potentially even changed back to the first term again.

The server system 110 can also identify terms that are synonyms through user actions with respect to the terms. For example, users applying different terms to the same item, such as the same attribute or object, can be a strong indicator that the terms are synonyms. One common situation is that different users may apply different labels to the same data element (e.g., a particular attribute, column, column, axis of a graph, etc.). When the server system 110 identifies that users have applied different labels for the same data element, the server system 110 can record the two terms as potential synonyms for each other. The illustrated example shows that users of the client devices 105b and 105c have both re-named the same column, “Col123,” but have used different names, “Day” and “Date.” The server system 110 detects that different names have been used for the same item and records these terms as potential synonyms. Optionally, the server system 110 may also record various contextual factors (e.g., related topics, related keywords, an associated department or user group, location, etc.) associated with these user actions, to assess whether the synonym relationship is applicable generally or perhaps only in certain contexts.

Although the example involving devices 105b, 105c shows users applying labels to a column of a data table, many other types of user actions can be detected and used to identify potential synonymous meaning. One example is the application of filter criteria to a particular visualization or to visualizations involving a particular topic or item. When users submit variations in filter criteria for a specific chart or graph, the differences in the different instances of filter criteria may indicate potential synonym relationships. Another example of a potential indicator of common meaning is the receipt of different queries that are similar or even identical except for a term or phrase being substituted in some instances. Other user actions that associate terms with items directly or indirectly can be used by the server system 110 to automatically detect potential synonym relationships.

Although even one instance of interchangeable usage may be sufficient to identify a potential synonym in some implementations, the server system 110 may consider aggregated indicators of synonyms across multiple documents, data sets, and contexts to improve accuracy. The server system 110 can measure instances of factors indicative of common meaning (e.g., co-occurrence, interchangeability, user actions treating terms as equivalent, etc.), and determine whether the results individually or collectively satisfy one or more criteria, such as meeting a threshold for a number of instances or percentage of uses of a term. The server system 110 can assess the similarity of meanings of terms, such as a corresponding data type (e.g., representing time, distance, quantity, etc.), unit of measure (e.g., hours, meters, dollars, etc.), related terms, part of speech (e.g., noun, adjective, verb, etc.), etc. These considerations can be assessed for each pair of terms considered to be potential synonyms. If the criteria are met, the server system 110 can designate a pair of terms as candidate synonyms for each other. In some implementations, when the indications of common meaning and usage are sufficiently strong (e.g., an appropriately high threshold is met), the synonyms can be added to the semantic graph data 123 and used in semantic graph operations.

In some implementations, once candidate synonyms are identified, further testing and monitoring can be performed to validate a synonym relationship before designating terms as synonyms. This can be particularly useful when usage by users in an organization suggests that two terms may be synonyms, but the indications do not meet a predetermined threshold for the number or consistency of uses showing equivalency. One technique for testing synonym relationships is to explicitly ask users whether two terms are synonyms. This can be done through a prompt in a specific context, such as on a page of a document corresponding to a specific topic, or in a more general setting. In some implementations, users can be asked to indicate whether two terms are synonyms as part of a CAPTCHA (“completely automated public Turing test to tell computers and humans apart”) type test. For example, as part of authentication to an analytics platform, a pair of terms from the set of candidate synonym pairs to be tested can be provided to a user, with a request for the user to indicate whether the terms are or are not synonymous. This test can be used to verify that a human user is in fact logging in, and also to accumulate confirmation information that can improve the content of the synonym information in the semantic layer.

As another technique for validating synonym relationships, the server system 110 can test synonym relationships by varying the terms that are provided to different users and monitoring user actions in response. For example, the server system 110 can implement a form of A/B testing where documents, prompts, user interface labels, and other content to a first group of users uses one term in a candidate synonym pair, while the same content uses a second term in the candidate synonym pair for the same content. The server system 110 can track the user interactions of users in both groups, to determine whether and to what extent user behavior changes due to the use of the different terms. If the server system 110 determines that levels of interaction are roughly equivalent, and that users do not rename the item to change the applied term from the candidate synonym pair, then the server system 110 can promote the candidate synonym pair to be included in the synonym data 123 and used in the semantic graph. On the other hand, if using the different terms from the candidate synonym pair results in significantly different levels of user interaction from one group of users to the next, or if users rename the item to change one of the terms in the candidate synonym pair more than a threshold frequency, the server system 110 can determine that the terms are not synonymous and so are not added to the semantic graph. This type of testing, as well as all other forms of testing, can be done for specific contexts as well as generally across all contexts, because some terms may be synonymous in one context but not another context.

In the example of FIG. 1, the server system 110 tests whether the terms “Date” and “Day” should be considered synonyms by sending different content to the devices 105d, 105e. The content can be a document, a dashboard, data set labels, search results, user interface controls, or other elements that will be presented to the users. Here, the same data for a visualization 140 is sent to both client devices 105d, 105e for display. However, for device 105d, the horizontal axis has a label 141 of “Date,” and for the device 105e the horizontal axis has a label 142 showing the candidate synonym “Day” instead. After sending the content, the server system 110 monitors whether the content is viewed and also the manner in which the users interact with the content. As noted above, if users accept the version with the candidate synonym and interact in roughly the same manner and extent as the version with the original term, this can indicate that the synonym relationship is valid and can be designated in the semantic graph, either generally or in certain contexts. On the other hand, if users rename the candidate synonym (e.g., from “Day” to “Date” or to some other term) or if the version with the candidate synonym results in significantly different usage measures (e.g., rate of interaction, amount of interaction, time spent viewing or interacting, etc.) the server system can detect this as an indication that the candidate synonym “Day” is not be synonymous with “Date.”

Synonym relationships can be evaluated and stored in a manner that reflects the nuances of natural language. Synonym relationships can be associated with scores, weights, or other measures that indicate a strength or relevance of terms to each other. For example, one pair of terms may be exactly synonymous and the server system 110 can assign a score of 1.0 to show 100% common meaning. Another pair of terms may be generally synonymous but not in all situations or among all users, and so the server system 110 may assign a different score, such as 0.70 to show an estimated 70% overlap in meaning or that the terms are interchangeable in 70% of instances. A pair of terms that is more weakly related, for example, used synonymously only rarely, may be assigned score indicating a lower level of commonality in meaning, such as 0.2. Just as the server system 110 may dynamically add and remove explicit designations of synonym relationships, the server system 110 may dynamically adjust the scores for synonym relationships on an ongoing basis, for example, as new documents or usage data are received that specify terms being used in different ways. In some implementations, different scores for synonym relationships may be assigned for different topics. For example, two terms may have a higher synonym score for one topic than another, or for one department of an organization than another, which can reflect the variations in natural language usage in different scenarios and among different users. Similarly, synonym scores can be assigned for different directions. For example, a first score may indicate how well Term A is a synonym for Term B (e.g., how well Term A is a suitable replacement for instances where Term B occurs), and a second score may indicate how well Term B is a synonym for Term A.

In some implementations, synonym relationships can be inferred from usage data from the semantic graph. Inferred synonym relationships may be determined and used without being explicitly designated or stored in specific synonym data sets. Even without synonym data 123 specifying synonym relationships, usage data indicating high levels co-occurrence, affinity between terms, and/or commonality in user actions can be indicative of synonymous meaning. One way that synonyms can be implicitly stored or detected is using the semantic graph to aggregate usage information involving different terms. This aggregation may based on the contexts of users or devices when a term occurs, or may apply generally across all usage data. The server system 110 (or another computer system providing the semantic graph service 120) can weight and combine usage information and based on the commonalities among the usage data, infer that two terms are used in sufficiently similar ways to be considered synonyms, at least for certain operations or contexts.

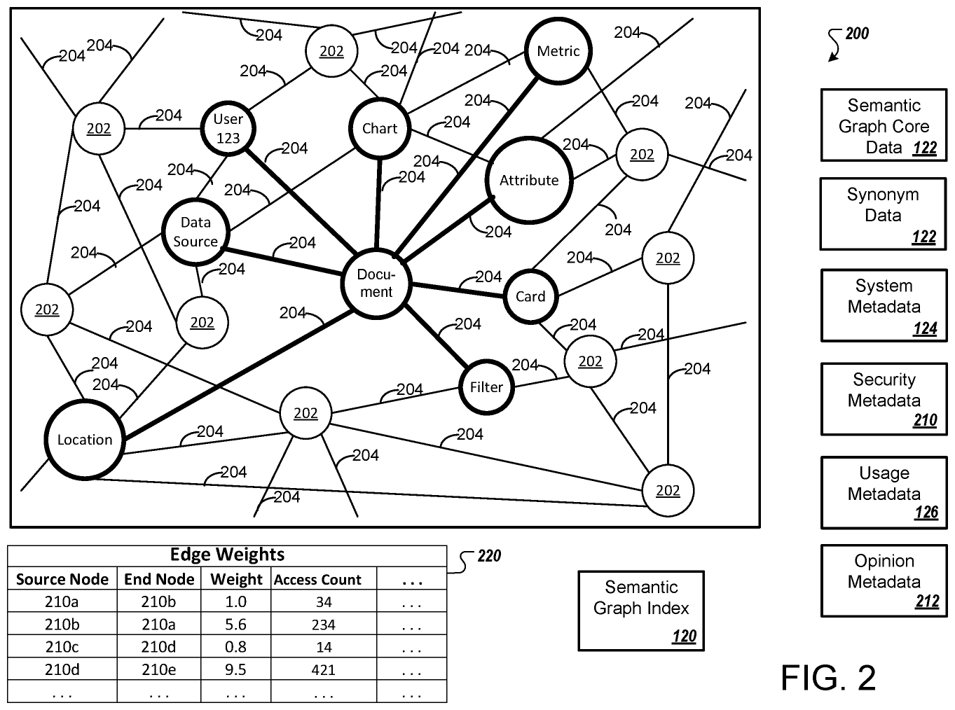

FIG. 2 illustrates an example illustration of a semantic graph 200. Objects are illustrated as nodes 202 and relationships or connections between the objects are illustrated as edges 204. Each node 202 can have a variety of information stored to describe the object it represents, e.g., an object type for the object, a location of the object (e.g., in a file system), an identifier for the object, attributes for the object, etc. The nodes 202 and edges 204 that identify the objects and their connections may be stored in the semantic graph core data 122, along with definitions, semantic tags, and more.

The edges 204 have weights 220 associated with them, e.g., values indicating magnitudes or strengths of the respective connections. Other information indicating the nature or character of the edges 204 can also be stored. Although the illustration only shows one edge 204 between each pair of nodes, there may be multiple different relationships between two objects, which may be represented as, for example, multiple edges 204 with different weights or an edge with multiple dimensions or aspects. In some implementations, an edge 204 and an associated weight represents an overall affinity of objects. In some implementations, Different edges 204 may represent different types of relationships, e.g., dependency (e.g., such as a document requiring data from a data source), co-occurrence, an object being an instance of a class or category, an object being a part of another object, and so on. Edges 204 may be directional. For example, the weight or strength of connection from Object A to Object B may be greater than the weight from Object B to Object A.

The semantic graph 200 has various types of metadata that describe aspects of the objects and connections. The system metadata 124 can indicate the configuration of the system and performance measures. This metadata can be generated and stored for each device or module of an enterprise system, e.g., client devices, content servers, database servers, individual applications, etc. The usage metadata 126 can include records of the accesses made throughout the system to any of the objects represented in the semantic graph 200, as well as the nature or type of access. Security metadata 210 can indicate security policies, permissions and restrictions, histories of security decisions (e.g., to grant or deny access) and so on. The Opinion metadata 212 can indicate explicit or inferred opinions and preferences of users. For example, the opinion metadata 212 can store information about sentiment derived from user actions or user documents, preferences for some items over others, and so on. These types of metadata and others can be associated to identifiers for specific nodes 202 and connections 204, allowing the semantic graph to store information about specific instances of how nodes 202 and connections 204 were accessed.

The system metadata 124, usage metadata 126, and other types of metadata can be log files that show historical information about how an enterprise system operated and how it was used. In some implementations, the metadata is received as real-time or near-real-time telemetry that is measured, logged, and reported as transactions occur. For example, the metadata can collect and store a stream or feed of information from client devices, databases, query processing modules, web servers, and any other component of the enterprise system. Thus, the information can be used to detect performance limitations or emerging trends in usage as they occur and with a very fine-grained level of precision. The telemetry can indicate individual requests, transactions, and operations. In some implementations, some aggregate measures can also be provided, such as an overall load level of a device.

As discussed above, a semantic graph can be a logical layer of software that describes information stored in data systems using human-readable terms and provides metadata that can aid analysis of the data. One of the primary functions is to provide people with way to query databases using common business terms without having to understand the underlying structure of the data model.

A semantic graph can store or have associated with it (i) metadata describing the data in human-understandable terms along with (ii) usage data about how often the data is accessed, by whom, and relationship data about how objects are used together in analysis scenarios. There are a number of objects and metadata that may be stored as part of a semantic graph implementation: data objects, content objects, user objects, usage metadata, security metadata, system metadata, a semantic graph index, opinion metadata, and action objects.

Different vendors often different terminology for similar concepts. For example, a “dimension” or “attribute” for a data object may both represent the same or similar concept, e.g., a value that represents a property of a data object. Similarly, a “measure” or “metric” in a data set may both refer to the same or similar concept, e.g., a value that provides quantitative indicator, such as a result of a calculation or function.

Data objects in the semantic graph can refer to objects that appear to users as business concepts. For example, “customers”, “products”, “revenue” and “profit” are all common data objects in the semantic graph. A user will typically see those data objects in a user interface and can query the underlying database by interacting with the data objects. For example, a user may query the database by requesting “customers” and “revenue”. The system will then query the database (or in many cases, multiple databases) to fetch the customer revenue data. Querying the system usually requires a number of complex database calls using SQL, MDX or APIs. From a user perspective, however, the complexity of how the data is stored, and the sophisticated query required to retrieve the results are automatically handled on behalf of the user.

Common types of Data objects include dimensions, measures, groups and sets, hierarchical structures, filters and prompts, geographic objects, date and time objects, and synonym objects. Dimensions (Attributes)—Dimensions and Attributes both refer to data that is typically (but not always) a noun, such as “Customer”, “Product”, “Country”, or “Account”. Dimensions can also have additional metadata associated with them to qualify them further. For example, a Dimension object can have further metadata describing it as a Person, which can, in turn, have further metadata describing the Person as being of type Employee.

Measures (Metrics or Key Figures)—Measures and Metrics both refer to data that would typically be used for calculations such as “Revenue”, “Profit”, “Headcount”, and “Account Balance”. Measures can also have additional metadata further describing how the Measure behaves. For example, additional metadata can describe whether bigger values or smaller values are “good” or whether a Measure represents a “currency”.

Groups and Sets—Groups and Sets refer to objects in the semantic graph that represent grouping of data elements. For example, the “Top 10 customers” may be a group that represents the top Customers by some measure (for example Revenue). Groups and Sets can be a simple grouping such as “My Customers=Company 1, Company 2, and Company 3” or a rules-based grouping such as “My Top Customers=top 10 Customers by Revenue for Year =2018”.

Hierarchical structures—Hierarchical structures provide metadata about the relationship between objects and object values in a semantic graph. For example, one such hierarchical structure may describe a Parts hierarchy where certain products are made up of parts.

Filters and Prompts—Filter and prompt objects provide a means to define variables that need to be set either by the programmer, system or end user prior to execution of the object. For example, a semantic graph may have a “Region” filter or prompt whose value must be defined prior to executing the query or content object that it is associated with.

Geographic objects—Geographic objects are objects associated with geographic concepts such as countries, regions, cities, latitude and longitude. Geographic metadata helps the consuming user or system map or perform geospatial calculations using the objects much more easily.

Date and Time objects—Date and Time objects are a special classification of objects that are associated with Dates and Times. This can be used for time based calculations (year over year analysis) or for displaying the object data on Date and Time-based output such as calendars.

Synonym objects—Synonym objects are a special classification of dimension and attribute objects that store alternate values to the values in the dimension objects. This is useful in cases where there are multiple common terms that are used to map to a specific value in the database. For example, in common usage, Coke and Coca-Cola are often used interchangeably when searching for information. The Synonym object stores such alternate values and maps them to a common value in the database. An example of a synonym object is shown in FIG. 3C.

Content objects in the semantic graph refer to content that is typically displayed to end users as an assembly of data objects. Content objects include:

Reports—Report objects are highly formatted, sectioned and paginated output such as invoices, multi-page tables and visualizations.

Dashboards—Dashboards objects are similar to Report objects in that they also display data and have formatting and visualizations. Dashboards differ from Reports in that they tend have summary data and key performance indicators instead of detailed pages of information.

Tables and Grids—Tables and grids represent data in tabular format (with rows and columns). Tables and grid often are included in Reports and Dashboards.

Visualizations—Visualization objects illustrate data in charts such as bar, pie and line charts.

Cards—Card objects store the key information for a specific topic and are built to augment and overlay third party applications with analytic information in the context of the user.

User objects are people, groups and organizations that are represented in the semantic graph. These objects represent user accounts and groups of user accounts and are used to provide system access, security and rights to other objects in a semantic graph. Users are particularly important in the semantic graph because they are the actors in the system that create, interact with, and use the other objects in the semantic graph. A semantic graph provides an understanding of the relationship between users and the objects in the semantic graph as well as the relationships between the users themselves.

Usage metadata is information stored in a semantic graph about the usage of the objects in a semantic graph. This additional usage data provides information about which objects are used by which users, which objects are used together and which objects are the most and least popular in the system. Usage metadata also contains the context of the user when she interacted with the system. For example, what type of device she was using, where she was, and what data context she was in. This usage metadata, in addition to the other metadata in a semantic graph, provides a means to find relevant information for different users and usage context. Usage metadata is the primary differentiator between a semantic layer and a semantic graph. While a semantic layer primarily describes data in business terms and provides relationship information between the objects as a means to map these business terms to database queries, a semantic graph stores usage information to provide additional information about the weight of the relationships between objects in the semantic graph. Usage metadata can also contain information about when and where objects are accessed.

Security metadata is information stored in a semantic graph about which users have access to which objects, which privileges they have on the objects, and which data they have access to. The Security metadata can also contain special concepts such as whether the objects are certified, contain personally identifiable information or contain sensitive information.

System metadata is data about how the objects in the system perform. This can include system information such as error rates and run times for the objects. This information can be used by users and system processes to optimize performance of the system. For example, the system can automatically notify content authors if their content is experiencing slow load times or high error rates. The system can also use the system metadata in the semantic graph to automatically perform maintenance to improve performance of content. For example, if a content object has slow performance and there are many users that access that content on a predictable basis, the system could potentially automatically schedule execution of the content and cache the results so as to provide users with improved performance.

A semantic graph index indexes key values in the semantic graph so as to provide fast search and retrieval times. These key values may be a variety of types of information, such as keywords, semantic tags, object or node identifiers, connection or edge identifiers, and so on.

Opinion metadata is opinion information about the objects in a semantic graph that is provided by the end users. For example, users could give a ‘thumbs up’ or ‘favorite’ content to indicate that they like or find it useful. Other mechanisms such as a star system or commentary can also be employed as means of storing opinion metadata in a semantic graph. Opinion metadata is useful alongside usage metadata and affinity between objects to help find content that is both relevant to the user's context and of value based on opinion.

Action objects describe actions that can be taken on other objects in a semantic graph. For example, there may be an Action object that takes a Date and Time object and converts it from one format (24 hour) to another (12 hour).

A semantic graph can provide a number of benefits. For example, a primary goal of the semantic graph is to make access to complex business data systems easy for people without database or programming skills. The semantic graph can provide common naming and semantics to represent complex data models with otherwise obscure or non-human-readable names. The semantic graph can provide or support various services built atop it (for example, search or machine-learning-driven recommendation services) with metadata, relationships, and user-based context information that can help answer user questions and recommend the most relevant content to users. The semantic graph can include (or have associated with it) security and audit information to help secure data assets based on user security access profiles.

FIGS. 3A-3D are tables illustrating examples of ways that synonym relationships may be stored or expressed in semantic graph data. The server system 110 of FIG. 1 can use any of these techniques or a combination of them.

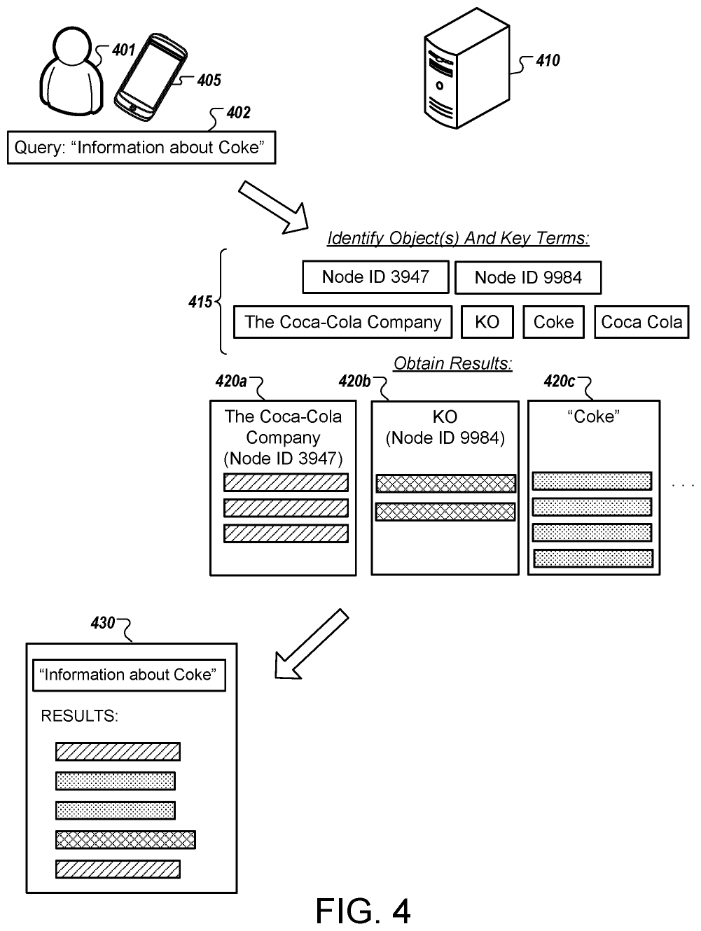

In FIG. 3A, node data 300 specifies the characteristics of a semantic graph node representing an object (e.g., a data object, a physical object, etc.). The node data 300 specifies identifying information, such as a node identifier, node type, and an object name. The node data 300 and other examples of node data discussed herein can also include identifiers or other references for the object the node represents, e.g., an object identifier for the object, a reference to a database record or data set for the object, and so on. In each instance where a node identifier (e.g., “Node ID”) for a node in the semantic graph is shown or discussed with respect to FIGS. 3A-3E and FIG. 4, an object identifier for the object the node corresponds to may be used in addition or as an alternative.

The node data 300 also includes synonyms for the object name. In the example, the name is the name of a company, “The Coca-Cola Company,” and the listed synonyms are “Coca-Cola,” “Coca Cola,” “Coke,” and “KO.” Optionally, these different synonyms may have associated scores that respectively indicate how strong the synonym relationships are to the object name. Similarly, there may be different scores for different data contexts (e.g., for different topics, data sets, applications, etc.) as well as different user contexts and device contexts. Although the values in the node data 300 are shown explicitly for clarity in illustration, the node data 300 may instead include a reference to another data source where the values may be retrieved. For example, the object name value may be a reference to a database field, and the name synonym entry may be a reference to an entry in a synonym table or another synonym data set. As a result, changes to the underlying data sources can be automatically propagated to the semantic graph data.

In FIG. 3B, an example of node data 310 for a company is shown, where the node data 310 does not specify synonyms. Instead, a separate set of synonym data 315 maps the node identifier (e.g., “3947”) to the set of synonyms (or to a reference to a data structure or data source where the synonym list is stored). The synonym data 315 can store entries that associate various different node identifiers with respective synonyms lists and synonym scores. In this arrangement, when nodes of the semantic graph are accessed, the system can look up the synonyms for a node using the node identifier. Other forms of indexing and retrieving the synonym data can alternatively be used.

In FIG. 3C, node data 320 is shown for a synonym object. In FIGS. 3A and 3B, the node data 300, 310 specified characteristics of a node representing a company, with the synonym data either being integrated with the node data 300 (FIG. 3A) or referencing the node 310 (FIG. 3B). By contrast, in FIG. 3C, a separate node is defined to represent the synonym relationship between terms, separate from the node data for the object(s) related to the terms. The node data 320 specifies a node with a type “Attribute” and a sub-type “Synonym,” to indicate the node indicates a synonym relationship. The node data 320 also indicates the various terms (e.g., Terms 1-5) that are considered synonyms. The node data 320 also indicates the node identifier for the object to which the terms are related. Other forms of specifying synonym nodes can also be used, such as designating a node that connects to nodes each representing various different objects or terms, in addition to or instead of listing the synonymous terms in the node data 320.

In FIG. 3D, a synonym relationship is specified using an edge or connection between two nodes in the semantic graph. Node data 330 specifies a node for the company “The Coca-Cola Company,” and node data 340 specifies a node for a stock symbol “KO” for the company. The stock symbol's node data 340 may optionally include data referencing the company's node, and the company's node data 330 may optionally include data referencing the stock symbol's node. Nevertheless, the synonym relationship between the names of the objects may be provided as data for an edge representing a connection between the two nodes, as shown by edge data 350, in addition to or instead of being stored in the node data 330, 340.

The edge data 350 includes one record (e.g., one row) for the synonym relationship between the terms “The Coca-Cola Company” and “KO.” Other records or rows can specify other synonym relationships or other types of relationships between nodes. The edge data 350 indicates an edge identifier for the edge, and specifies that the edge has a “Synonym” edge type. The edge data 350 specifies the two nodes involved (e.g., using identifiers “3947” and “9984”) to specify which nodes are connected. The edge data 350 also indicates two weights or scores for the strength or applicability of the synonym relationship. The first weight or “forward weight” indicates how well the first node's name “The Coca-Cola Company” is a synonym for the second node's name, “KO.” The first weight or “forward weight” indicates how well the first node's name “The Coca-Cola Company” is a synonym for the second node's name, “KO.” Here, the two weights are different for the different directions of connecting the nodes, showing that “The Coca-Cola Company” can replace “KO” more effectively or more frequently than the reverse. In some implementations, the connection between the two nodes can be expressed as two edges extending in different directions to reflect this difference.

The edge data 350 also indicates contextual factors that increase or decrease the applicability of the synonym relationship. For example, the context of terms or topics “stock” and “soda” strengthen the applicability of the synonym relationship, while the context of “boxing” decreases the applicability of the synonym relationship. In some implementations, the synonym relationship may have different weights for different contexts, or may be considered to exist as a connection only for specific contexts.

FIG. 3E illustrates an example of usage data that references nodes of the semantic graph. The usage data can indicate synonym relationships implicitly, or may be analyzed to define synonym relationships more explicitly. The usage data 370 includes records of different actions that user have taken. One record indicates that a user performed a search that involved node ID “3947.” Another record indicates that a user generated a visualization that involved node ide “9984.” The system can create usage logs that indicate actions of many different types, e.g., opening documents, making edits to documents, applying labels to data, generating document elements, applying filters, and so on.

The system can assess the usage data 360 for various users and action types to determine usage statistics 370 that involve a pair of nodes or terms. For example, the system can determine a number of instances where both nodes are linked to the same data element. In some implementations, rather than just being associated tags or related entities, these can be instances where the data element is defined using the node, such as when the name of the data element is defined using the node. Other measures can reflect results of testing that the system initiates, for example, indicating the frequency of interaction and frequency that users rename items when the names from different objects are used. These measures can be used to determine whether a synonym relationship should be added, to determine which contexts a synonym relationship should be used in, and/or to adjust the weights or scores for the synonym relationship. The system can compare the usage statistics 370 with predetermined thresholds, ranges, or profiles to determine whether synonym relationships exist. The system can determine statistics for known synonyms and use those levels to set the appropriate thresholds, ranges, or synonym profiles for identifying a synonym relationship.

FIG. 4 illustrates an example of using semantic graph data involving synonyms. In the example, a user 401 enters a query 402, “Information about Coke,” to a client device 405. A server system 410 receives the query and sends a request to a semantic graph service to identify objects and key terms related to the query. In the example, the semantic graph service responds with information 415 indicating that the term “Coke” has various other synonyms, such as “The Coca-Cola Company,” “KO,” and “Coca Cola.” The information 415 also indicates that objects corresponding to semantic graph node identifiers “3947” and “9984” are related to the query. The information 415 may also include, for example, relevance scores, weights, or other measures that indicate how closely related the terms and objects are to the query 402. These measures may be based on the query 402 as a whole, not just the single word “Coke,” and can also be based on contextual factors (e.g., identity or profile of the user 401, previous queries of the user 401, a location of the user 401 or the device 405, a document or application currently open on the device 405, terms or topics used by others in the same department as the user 401, and so on). The information 415 can also indicate various contextual factors that are associated with the different objects or terms indicated, which can be used later in assessing the relevance of search results (e.g., to sort, rank, or filter search results).

The server system 410 uses the information from the semantic graph to identify search results. A first set of search results 420a is obtained using the object with node identifier “3947,” a second set of search results 420b is obtained using the object with node identifier “9984,” a third set of search results 420c is obtained using the term “Coke,” and so on. As illustrated, different variations of terms and different objects referenced in the semantic graph may allow different documents and data to be retrieved, allowing a broader and more complete set of results.

The server system 410 evaluates the various sets of search results 420a-420c and assigns information retrieval scores to each result, allowing the system to rank the results and provide a set of the highest-ranking results to the client device 405 for display. The user interface 430 shows the search results being presented to the user 401, with the final set of results having elements identified and scored using various different elements from the semantic graph data.

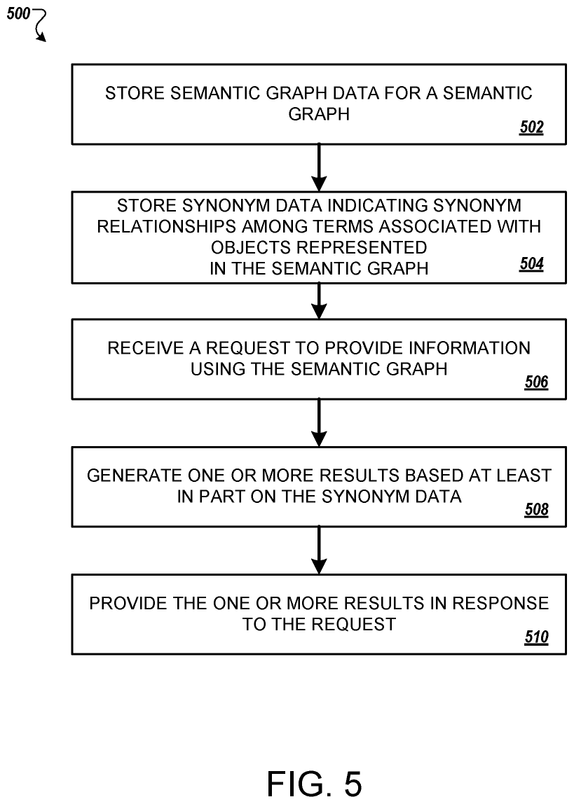

FIG. 5 is a flow diagram illustrating an example of a process 500 for indicating synonym relationships using semantic graph data. The process 500 can be performed by one or more computers, e.g., a server system, a client device, or other devices or combinations of devices.

The one or more computers store semantic graph data indicating a semantic graph (502). The semantic graph includes elements representing objects and that indicates relationships among the objects. The elements of the semantic graph can include nodes representing the respective objects, and wherein the semantic graph includes edges between the nodes to indicate the relationships among the objects.

In some implementations, the objects represented by the elements of the semantic graph can be objects identified from a database for a particular organization. The semantic graph can include connections among elements representing the objects, wherein the connections are determined (i) from data or documents of a particular organization and (ii) user interactions of users in the particular organization.

The one or more computers store synonym data in association with the semantic graph data (504). The semantic graph data indicates synonym relationships among terms associated with the objects. The synonym data can include or otherwise refers to identifiers for the elements of the semantic graph or the objects represented by the elements. Synonym relationships may be represented by connections in the semantic graph (e.g., edges or connections between nodes). Synonym relationships can additionally or alternatively be indicated by objects, or by data stored within object. As another example, synonym relationships can be stored in metadata or other data that associates terms with object or connection identifiers.

The synonym data can include scores indicating different strengths of synonym relationships among different pairs of terms or among groups of terms. The synonym data can indicate synonym relationships that were manually entered by a user. The synonym data can include scores that indicate differing strengths of relationships for different synonym pairs. The scores can be altered based on user interactions with data elements associated with the terms in the synonym pairs.

The one or more computers receives a request to provide information using the semantic graph (506). As an example, the request may be a request for information about an object. As another example, the request may be a request to perform a search based on a query. As another example, the request may be a request for content to provide in a user interface. As another example, the request may be a request to retrieve a document. In some implementations, the request may be a request for synonyms of a term or synonyms related to an object represented in the semantic graph.

The one or more computers generates one or more results based at least in part on the synonym data stored in association with the elements of the semantic graph (508). For example, when processing a query, the synonym data can be used to identify additional terms to expand or enhance the query. For example, the synonyms can be used to re-write the query to include additional synonyms for identifying candidate matches to the query criteria. Synonym information may be used to rank or sort search results as well. As another example, the synonym information may be used to expand a set of recommended content items. As another example, the synonym information may be used to provide a variety of suggested queries or query autocompletions. In response to a request for a document or other content, the synonym information may be used to identify related or recommended content.

The one or more computers provide the one or more results in a response to the request (510). For example, data indicating the results can be provided to a client device over a network, such as the Internet. The results can be provided as data for presentation, such as by synthesized speech output or by display in a user interface.

In some implementations, the one or more computers can monitor user actions, document content, and/or content of data stores over time, and then dynamically adjust synonym relationships indicated by the synonym data. This can include adjusting the scores or weights indicating the strength of connections in the semantic graph between objects and between terms. Adjustments can be made incrementally on an ongoing basis as usage data is received and processed. Adjustments can be discrete, for example, in response to completing a validation process or in response to determining that at least a minimum threshold level of connection is present based on the usage data.

In some implementations, access to the semantic graph can be provided as a semantic graph service accessible through an application programming interface. Receiving the request can include receiving a query for the semantic graph service through the application programming interface. Providing the one or more results can include providing data identifying objects represented in the semantic graph as output of the semantic graph service.

In some implementations, a first term is identified as a candidate synonym for a second term. The one or more computers validate the candidate synonym relationship based on usage information indicating user actions with respect to the first term and the second term. The usage information can be obtained from the semantic graph, such as by obtaining scores for connections or edges between nodes involving objects or terms, and/or by aggregating usage information using the semantic graph. Based on validating the candidate synonym relationship, updating the synonym data to indicate that the first term is a synonym for the second term.

Candidate synonyms can be identified by detecting that similar or related user actions involving terms. For example, to identify a first term as a candidate synonym for a second term, the one or more computers can determine that one or more users have applied the first term as a label for an item, and can determine that one or more users have applied the second term as a label for the item.

Candidate synonyms can be identified by detecting terms used in the same or similar context. For example, to identify a first term as a candidate synonym for a second term, the one or more computers can determine a measure of co-occurrence, interchangeability, or affinity for the first term and the second term based on contents of documents or data. This data may be for a particular organization, such as a document library or database for a particular company. The one or more computers can determine that the measure satisfies a predetermined threshold in order to designate the terms as candidate synonyms for each other.

To validate a candidate synonym relationship, the one or more computers can provide first data to a first set of users, the first data including the first term. The first data may be a document, a notification, a user interface, a visualization, a user interface control, etc. The one or more computers can provide second data to a second set of users, where the second data comprises the first data with the second term used in place of the first term. The one or more computers can track actions of users in the first set of users and the second set of users after presentation of the first data and the second data. For example, the one or more computers can determine a duration of interaction, a frequency of interaction, a type of interaction (e.g., whether or not users change the first term or second term), or other measure of user actions. Based on the tracked actions, the one or more computers can determine that the first term is a synonym for the second term.

In some implementations, validating a candidate synonym relationship includes analyzing instances of the first term and the second term in different contexts to determine whether the synonym relationship remains valid in each of the different contexts.

Synonym data can be updated to indicate that the first term is a synonym for the second term comprises updating the semantic graph data to add a synonym to data describing one or more elements of the semantic graph. Updating the synonym data to indicate that a first term is a synonym for a second term can include updating the semantic graph data to add a new node to the semantic graph that specifies that the first term is a synonym for the second term. Updating the synonym data to indicate that a first term is a synonym for a second term can include updating the semantic graph data to add a new edge to the semantic graph that specifies that the first term is a synonym for the second term.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by one or more computers, the method comprising:
storing semantic graph data indicating a semantic graph that includes elements representing objects and that indicates relationships among the objects;
storing, in association with the semantic graph data, synonym data that indicates synonym relationships among terms associated with the objects;
receiving a request to provide information using the semantic graph;
generating one or more results based at least in part on the synonym data stored in association with the elements of the semantic graph; and
providing the one or more results in a response to the request.

2. The method of claim 1, wherein storing the synonym data comprises storing synonym data that refers to identifiers for the elements of the semantic graph or the objects represented by the elements.

3. The method of claim 1, wherein storing the synonym data comprises storing scores indicating different strengths of synonym relationships among different pairs of terms.

4. The method of claim 1, wherein storing the synonym data comprises storing data indicating a synonym relationship that was manually entered by a user.

5. The method of claim 1, wherein the objects represented by the elements are identified from a database for a particular organization.

6. The method of claim 1, wherein the semantic graph includes connections among elements representing the objects, wherein the connections are determined (i) from data or documents of a particular organization and (ii) user interactions of users in the particular organization.

7. The method of claim 1, comprising providing access to the semantic graph as a semantic graph service accessible through an application programming interface;
wherein receiving the request comprises receiving a query for the semantic graph service through the application programming interface; and
wherein providing the one or more results comprises providing data identifying objects represented in the semantic graph as output of the semantic graph service.

8. The method of claim 1, comprising:
identifying a first term as a candidate synonym for a second term;
validating the candidate synonym relationship based on usage information indicating user actions with respect to the first term and the second term; and
based on validating the candidate synonym relationship, updating the synonym data to indicate that the first term is a synonym for the second term.

9. The method of claim 8, wherein identifying the first term as a candidate synonym for the second term comprises:
determining that one or more users have applied the first term as a label for an item; and
determining that one or more users have applied the second term as a label for the item.

10. The method of claim 8, wherein identifying the first term as a candidate synonym for the second term comprises:
determining a measure of co-occurrence, interchangeability, or affinity for the first term and the second term based on contents of documents or data of a particular organization; and
determining that the measure satisfies a predetermined threshold.

11. The method of claim 8, wherein validating the candidate synonym relationship comprises:
providing first data to a first set of users, the first data including the first term;
providing second data to a second set of users, wherein the second data comprises the first data with the second term used in place of the first term;
tracking actions of users in the first set of users and the second set of users after presentation of the first data and the second data; and
determining, based on the tracked actions, that the first term is a synonym for the second term.

12. The method of claim 8, wherein validating the candidate synonym relationship comprises analyzing instances of the first term and the second term in different contexts to determine whether the synonym relationship remains valid in each of the different contexts.

13. The method of claim 8, wherein updating the synonym data to indicate that the first term is a synonym for the second term comprises updating the semantic graph data to add a synonym to data describing one or more elements of the semantic graph.

14. The method of claim 8, wherein updating the synonym data to indicate that the first term is a synonym for the second term comprises updating the semantic graph data to add a new node to the semantic graph that specifies that the first term is a synonym for the second term.

15. The method of claim 8, wherein updating the synonym data to indicate that the first term is a synonym for the second term comprises updating the semantic graph data to add a new edge to the semantic graph that specifies that the first term is a synonym for the second term.

16. The method of claim 1, comprising monitoring at least one of user actions, document content, or content of data stores to adjust synonym relationships indicated by the synonym data.

17. The method of claim 1, wherein the synonym data includes scores that indicate differing strengths of relationships for different synonym pairs;
wherein the method comprises altering the scores based on user interactions with data elements associated with the terms in the synonym pairs.

18. The method of claim 1, wherein the elements of the semantic graph include nodes representing the respective objects, and wherein the semantic graph includes edges between the nodes to indicate the relationships among the objects.

19. A system comprising:
one or more computers; and
one or more computer-readable media storing instructions that, when executed by the one or more computers, cause the one or more computers to perform operations comprising:
storing semantic graph data indicating a semantic graph that includes elements representing objects and that indicates relationships among the objects;
storing, in association with the semantic graph data, synonym data that indicates synonym relationships among terms associated with the objects;
receiving a request to provide information using the semantic graph;
generating one or more results based at least in part on the synonym data stored in association with the elements of the semantic graph; and
providing the one or more results in a response to the request.

20. One or more non-transitory computer-readable media storing instructions that, when executed by one or more computers, cause the one or more computers to perform operations comprising:
storing semantic graph data indicating a semantic graph that includes elements representing objects and that indicates relationships among the objects;
storing, in association with the semantic graph data, synonym data that indicates synonym relationships among terms associated with the objects;
receiving a request to provide information using the semantic graph;
generating one or more results based at least in part on the synonym data stored in association with the elements of the semantic graph; and
providing the one or more results in a response to the request.
